(19) United States
(12) Patent Application Publication
(10) Pub. No.: US 2012/0044715 A1
(43) Pub. Date: Feb. 23, 2012

(54) BACKLIGHT MODULE AND DISPLAY DEVICE HAVING THE SAME

(76) Inventors: Han-Wen Tsai, Hsinchu City (TW); Chih-Chieh Yu, Hsinchu City (TW); Ming-Feng Kuo, Hsinchu City (TW)

(21) Appl. No.: 13/162,878

(22) Filed: Jun. 17, 2011

(30) Foreign Application Priority Data
Aug. 18, 2010 (TW) 099127517

(51) Int. Cl. F21V 7/22

(52) U.S. Cl. 362/612; 362/613

(57) ABSTRACT

A backlight module includes a light guide plate, at least one first light source, and at least one second light source. A first light incident surface and a second light incident surface are alternately arranged on a light incident side of the light guide plate and form an angle with each other. The first light source is disposed adjacent to the first light incident surface, and a light beam emitted by the first light source is guided towards a left half of the light guide plate. The second light source is disposed adjacent to the second light incident surface, and a light beam emitted by the second light source is guided towards a right half of the light guide plate. The first light source and the second light source are alternately turned on and off in succession.

### BACKGROUND OF THE INVENTION

a. Field of the Invention

The invention relates to a backlight module and a display device having two different viewing angles.

b. Description of the Related Art

Referring to FIG. 10, a display device 100 includes a light guide plate 102, a right-side light source 104, a left-side light source 106, a prism sheet 108, and a display panel 110. The right-side light source 104 and the left-side light source 106 are alternately tuned on and off in succession, and the prism sheet 108 deflects a light beam from the right-side light source 104 and a light beam from the left-side light source 106 to the left-hand side and the right-hand side, respectively. Accordingly, two eyes of a viewer receive light beams having two different light-emitting angles to generate a stereoscopic visual effect. According to the above design, a plurality of V-shaped microstructures (not shown) having gradually-varied inclined angles are formed on a bottom side of the light guide plate 102. However, such type of microstructures is difficult to be produced to result in high fabrication costs and a low production yield. Besides, under the design where two light sources 104 and 106 are disposed on two sides of a single light guide plate 102, the influence of the light source on one side over the luminous uniformity should be also considered when the distribution of microstructures on the other side is to be adjusted to control the light output uniformity. Therefore, in order to improve the light output uniformity of the entire light guide plate 102, the distribution of microstructures may not be optimized without restriction to result in low light utilization efficiency.

Referring to FIG. 11, a display device 200 includes two light guide plates 202 and 204, a light source 206 disposed on one side of the light guide plate 202, a light source 208 disposed on one side of the light guide plate 204, and a display panel 210. The light source 206 and the light source 208 are alternately tuned on and off in succession, and light beams emitted by the light source 206 and the light source 208 are output through microstructures 202a and 204a, respectively, towards two different directions. Therefore, two eyes of a viewer receive respective image beams to generate a stereoscopic visual effect. However, such design requires two light guide plates 202 and 204 to result in high fabrication costs and assembly efforts. Besides, the upper light guide plate 202 is liable to interfere with a light output pattern of the lower light guide plate 204 to cause difficulties in light control.

In addition, Taiwan patent publication no. 200615663 discloses a light-emitting element having light-emitting diodes, and U.S. Pat. No. 7,528,893 and US patent publication no. 2006/0132673 both disclose a display device with a backlight module.

### BRIEF SUMMARY OF THE INVENTION

The invention provides a display device having two different viewing angles and being capable of providing two different images for viewers. Other objects and advantages of the invention may be further illustrated by the technical features broadly embodied and described as follows.

In order to achieve one or a portion of or all of the objects or other objects, an embodiment of the invention provides a backlight module including a light guide plate, at least one first light source, and at least one second light source. The light guide plate has a light incident side, a bottom side, and a light-emitting side. The bottom side is opposite the light-emitting side, at least one first light incident surface and at least one second light incident surface are alternately arranged on the light incident side, and the first light incident surface forms an angle with the second light incident surface. The first light source is disposed adjacent to the first light incident surface. A light beam emitted by the first light source is capable of entering the light guide plate through the first light incident surface. The second light source is disposed adjacent to the second light incident surface. A light beam emitted by the second light source is capable of entering the light guide plate through the second light incident surface. A central axis across a center of the light incident side divides the light guide plate into a first half and a second half. The light beam emitted by the first light source is capable of being guided towards the first half, and the light beam emitted by the second light source is capable of being guided towards the second half. The first light source and the second light source are alternately turned on and off in succession.

In one embodiment, a light-emitting surface of the first light source is substantially parallel to the first light incident surface, and a light-emitting surface of the second light source is substantially parallel to the second light incident surface.

In one embodiment; the first light incident surface is slanted with a positive slope, and the second light incident surface is slanted with a negative slope.

In one embodiment, the light incident side further includes a connecting surface connecting the first light incident surface and the second light incident surface, and an inclined direction of the first light incident surface slanted to the connecting surface is different from an inclined direction of the second light incident surface slanted to the connecting surface.

In one embodiment, the backlight module further includes a light-converging structure. The light-converging structure is formed on the bottom side of the light guide plate to narrow a light emitting angle of the light guide plate in a vertical direction. A light-guiding microstructure is formed on at least one of the first light incident surface and the second light incident surface.

According to another embodiment of the invention, a display device includes a light guide plate, at least one first light source, at least one second light source, a display panel, and an image light source synchronization unit. The light guide plate has a light incident side, a bottom side, and a light-emitting side. The bottom side is opposite the light-emitting side, at least one first light incident surface and at least one second light incident surface are alternately arranged on the light incident side, and the first light incident surface forms an angle with the second light incident surface. The first light source is disposed adjacent to the first light incident surface, a light beam emitted by the first light source is capable of entering the light guide plate through the first light incident surface, and a light-emitting surface of the first light source is substantially parallel to the first light incident surface to guide the light beam emitted by the first light source towards a left-hand side in space. A second light source is disposed adjacent to the second light incident surface, a light beam emitted by the second light source is capable of entering the light guide plate through the second light incident surface, a light-emitting surface of the second light source is substantially parallel to the second light incident surface to guide the light beam emitted by the second light source towards a right-hand side in space. The first light source and the second light source are alternately turned on and off in succession. The display panel is capable of displaying a left-side image and a right-side image alternately. The image light source synchronization unit displays the left-side image when the first light source device is turned on and the second light source device is turned off and displays the right-side image when the first light source device is turned off and the second light source device is turned on.

In one embodiment, the left-side image is provided for a viewer on the left-hand side, and the right-side image is provided for a viewer on the right-hand side.

In one embodiment, the left eye and the right eye of a viewer observe the right-side image and the left-side image, respectively.

In summery, the embodiment or embodiments of the invention may have at least one of the following advantages.

According to the above embodiments, the light guide plate has a plurality of light incident surfaces slanted with different slopes, and a plurality of light sources have light-emitting surfaces correspondingly slanted with different slopes. Therefore, different viewing angles of a display device are achieved to allow viewers on a left-hand side and a right-hand side to see their respective images or to allow a stereoscopic visual effect for a viewer. Compared with conventional designs, since only one light guide plate is needed and the specific microstructures having gradually-varied inclined angles are not necessary, the fabrication costs are reduced and the product yield is increased. Besides, since the light sources are disposed on a single side of the light guide plate, the light output pattern and the overall luminous uniformity of the light guide plate is easily controlled, and the light-utilization efficiency is increased.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram of a display device according to an embodiment of the invention.

FIG. 2 shows a schematic diagram of a backlight module according to an embodiment of the invention.

FIGS. 3 and 4 show schematic diagrams of light output patterns of a backlight module according to an embodiment of the invention.

FIG. 5 shows simulation results of viewing angles of a display device according to an embodiment of the invention.

FIG. 6 shows a schematic diagram illustrating a definition of a horizontal direction and a vertical direction on the basis of a viewer.

FIG. 7 shows a schematic diagram of a light-converging structure according to an embodiment of the invention.

FIG. 8 shows a schematic diagram of a backlight module according to another embodiment of the invention.

FIG. 9 shows a schematic diagram of a backlight module according to another embodiment of the invention.

FIG. 10 shows a schematic diagram of a conventional display device having two different viewing angles.

FIG. 11 shows a schematic diagram of another conventional display device having two different viewing angles.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

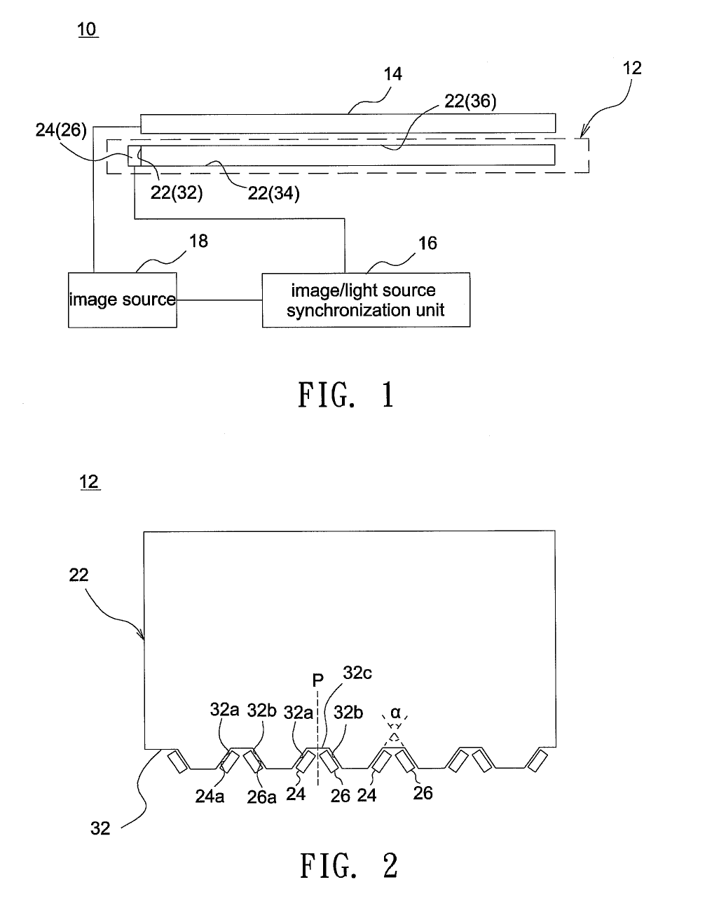

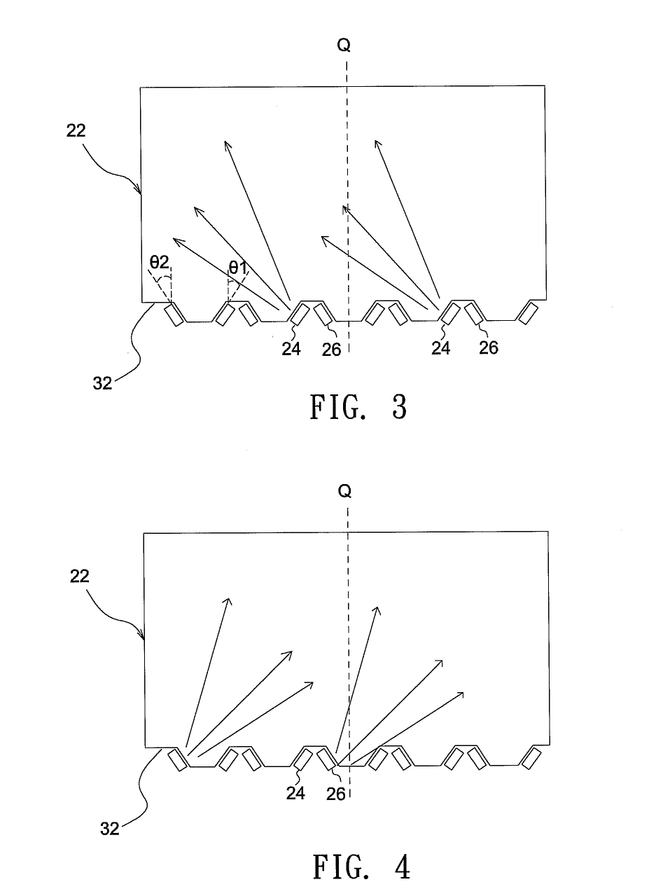

As shown in FIG. 1, a display device 10 includes a backlight module 12, a display panel 14, and an image light source synchronization unit 16. Referring to both FIG. 1 and FIG. 2, the backlight module 12 includes a light guide plate 22, at least one first light source 24, and at least one second light source 26. The light guide plate 22 has a light incident side 32, a bottom side 34, and a light-emitting side 36, and the light-emitting side 36 is opposite the bottom side 34. A first light incident surface 32a and a second light incident surface 32b are alternately arranged on the light incident side 32 of the light guide plate 22 and form an angle cc with each other. The first light source 24 is disposed adjacent to the first light incident surface 32a. A light beam emitted by the first light source 24 is capable of entering the light guide plate 22 through the first light incident surface 32a. The second light source 26 is disposed adjacent to the second light incident surface 32b. A light beam emitted by the second light source 26 is capable of entering the light guide plate 22 through the second light incident surface 32b. In this embodiment, a light-emitting surface 24a of the first light source 24 and the first light incident surface 32a are substantially parallel to each other, and a light-emitting surface 26a of the second light source 26 and the second light incident surface 32b are substantially parallel to each other.

Further, in this embodiment, the light incident side 32 of the light guide plate 22 further includes a connecting surface 32c connecting the first light incident surface 32a and the second light incident surface 32b. In one embodiment, the first light incident surface 32a and the second light incident surface 32b are substantially symmetrical with respect to a central axis P across a center of the connecting surface 32c. In one embodiment, an inclined direction of the first light incident surface 32a slanted to the connecting surface 32c is different from an inclined direction of the second light incident surface 32b slanted to the connecting surface 32c. For example, the first light incident surface 32a is slanted with a positive slope, and the second light incident surface 32b is slanted with a negative slope. Therefore, the light-emitting surface 24a of the first light source 24 is slanted with a positive slope, and the light-emitting surface 26a of the second light source 26 is slanted with a negative slope. In addition, each of the first light source 24 and the second light source 26 may be a light-emitting diode.

It should be noted that, in the specification and appending claims, the wordings “right-hand side (right-side)” and “left-hand side (left-side)” are only used to represent two opposite orientations in space but not to limit the scope of the invention. For example, as shown in FIG. 3, a central axis Q across a center of the light incident side 32 divides the light guide plate 22 into a left half and a right half, and a light beam directed towards the left half of the light guide plate 22 is to propagate in the left-hand side in space after exiting the light guide plate 22. As shown in FIG. 4, a light beam directed towards the right half of the light guide plate 22 is to propagate in the right-hand side in space after exiting the light guide plate 22. In this embodiment, the first light source 24 and the second light source 26 are designed to be alternately turned on and off in succession. As shown in FIG. 3, at a first time point when the first light source 24 is turned on and the second light source 26 is turned off, the light guide plate 22 is only spread with the light beam emitted by the first light source 24, and the light beam emitted by the first light source 24 propagates towards the left half of the light guide plate 22. As shown in FIG. 4, at a next time point when the first light source 24 is turned off and the second light source 26 is turned on, the light guide plate 22 is only spread with the light beam emitted by the second light source 26 and the light beam emitted by the second light source 26 propagates towards the right half of the light guide plate 22. Therefore, under the condition that each of the left-hand side and the right-hand side in space is found a viewer, the image light source synchronization unit 16 enables, at a first time point, an image source 18 to provide an image A and meanwhile turn on the first light source 24 and turn off the second light source 26 to allow the viewer on the left-hand side to observe the image A. Similarly, the image light source synchronization unit 16 enables, at a next time point, the image source 18 to provide an image B and meanwhile turn off the first light source 24 and turn on the second light source 26 to allow the viewer on the right-hand side to observe the image B. Since the display panel 14 alternately and continuously displays the image A and the image B, the viewer on the left-hand side may observe the image A with continuous frames and the viewer on the right-hand side may observe the image B with continuous frames due to persistence of vision. That is, the viewers on the left-hand side and the right-hand side may observe their respective images. In comparison, as for a single viewer, the image light source synchronization unit 16 enables, at a first time point, the image source 18 to provide an image for the left eye and meanwhile turn on the first light source 24 and turn off the second light source 26. Similarly, the image light source synchronization unit 16 enables, at a next time point, the image source 18 to provide an image for the right eye and meanwhile turn off the first light source 24 and turn on the second light source 26. Thus, the display panel 14 alternately and continuously displays the image for the left eye and the image for the right eye to thereby generate a stereoscopic visual effect.

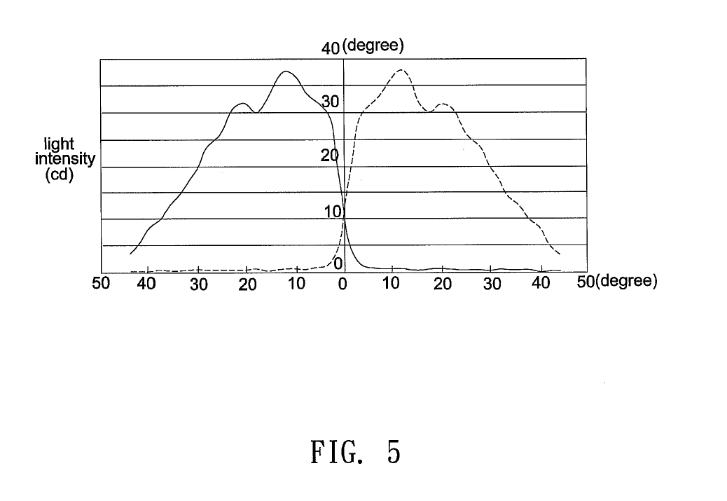

FIG. 5 shows simulation results of viewing angles of a display device according to an embodiment of the invention, where an angle θ1 formed between the light-emitting surface 24a and a vertical direction is 45°, an angle θ2 formed between the light-emitting surface 26a and the vertical direction is 45° (θ1 and θ2 are labeled in FIG. 3), the ordinate represents the light intensity (cd), and the abscissa represents the light-emitting angle. Further, in FIG. 5 solid lines represent the distribution of light intensity in relation to light-emitting angles of the first light source 24, and dashed lines represent the distribution of light intensity in relation to light-emitting angles of the second light source 26. Further, in one embodiment, the angle θ1 between the light-emitting surface 24a of the first light source 24 and the vertical direction is in the range of 20°≦θ1≦60°, and the angle θ2 between the light-emitting surface 26a of the second light source 26 and the vertical direction is in the range of 20°≦θ2≦60°. Certainly, the angles θ1 and θ2 are not limited and may be designed according to actual demands.

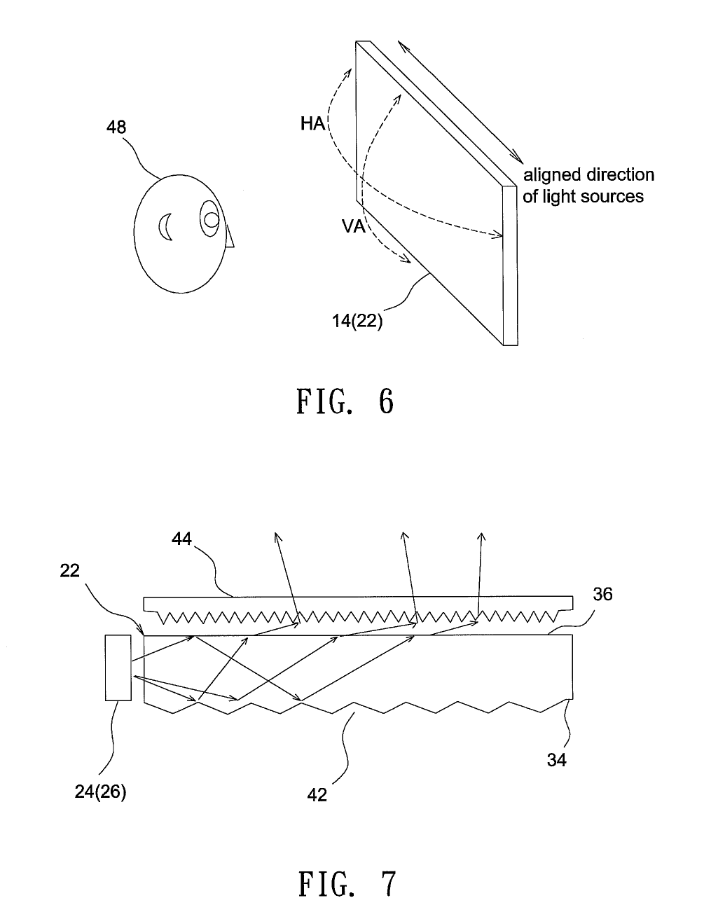

As shown in FIG. 6, a horizontal direction HA and a vertical direction VA with respect to the light guide plate 22 or the display device 14 are defined based on the visual field of an observer 48. The light sources 24 and 26 are arranged on the light incident side of the light guide plate 22 in a direction substantially parallel to the horizontal direction HA, and the central axis Q of the light guide plate 22 is substantially parallel to the vertical direction VA. According to the above embodiments, since the light-emitting direction of the light sources 24 and the light-emitting direction of the light sources 26 are towards the left-hand side and the right-hand side respectively, a light output pattern including two independent and different light-emitting angle distributions exists in the horizontal direction HA. In that case, the capability of microstructures formed on the light guide plate 22 to deflect light propagating in the horizontal direction HA is reduced to ensure that a demanded light output pattern is obtained. In comparison, the capability of microstructures formed on the light guide plate 22 to deflect light propagating in the vertical direction VA is maintained to narrow the light-emitting angle in the vertical direction VA. Therefore, as shown in FIG. 7, a light-converging structure is formed on the bottom side 34 of the light guide plate 22 to narrow the light-emitting angle in the vertical direction VA. The light-converging structure may be a V-shaped groove 42, and a longitudinal direction of the V-shaped groove 42 is substantially parallel to an aligned direction of the light sources 24 and 26 (or an extending direction of the light incident side). The V-shaped groove 42 is capable of narrowing the light-emitting angle of the light guide plate 22 in the vertical direction VA, and, in case a prism sheet 44 is disposed adjacent to the light-emitting side 36, a light beam with a relatively large incident angle is deflected by the prism sheet 44 towards an on-axis viewing direction. Certainly, the light-converging structure is not limited to the V-shaped structure 42, as long as the effect of narrowing the light-emitting angle in the vertical direction VA and maintaining the light output pattern with two independent light-emitting angle distributions in the horizontal direction HA is provided.

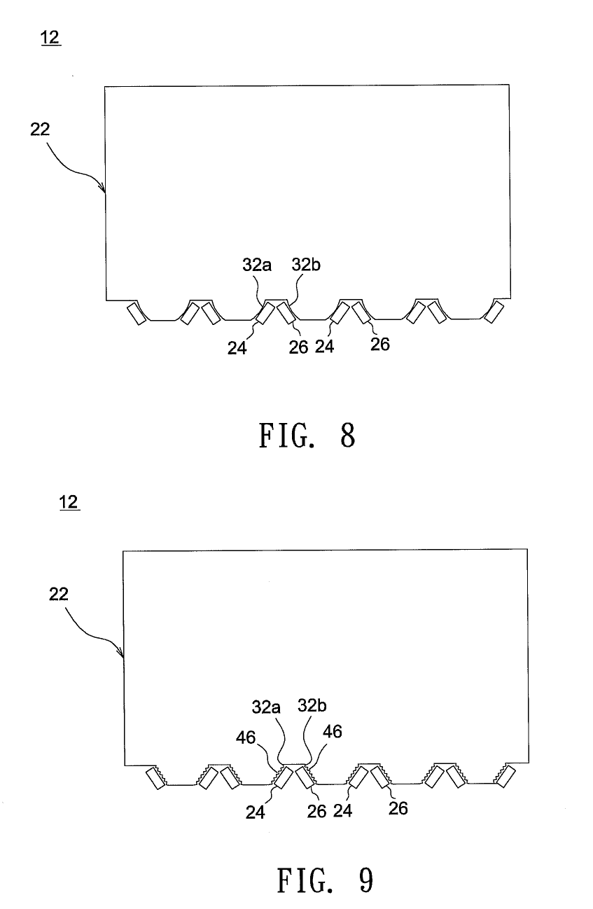

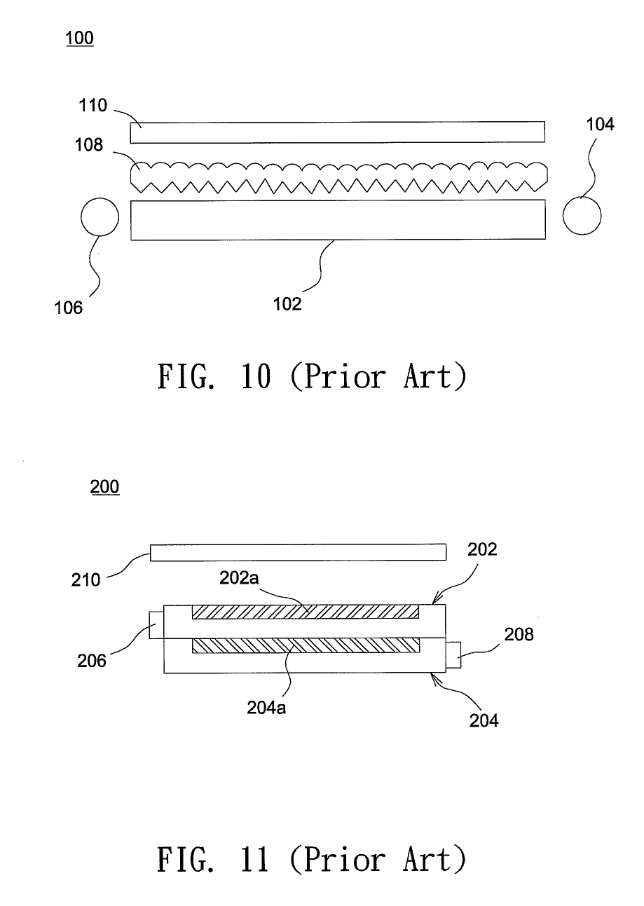

Furthermore, the shape of the first light incident surface 32a and the second light incident surface 32b are not limited and may be a planar surface (shown in FIG. 2), a curved surface (shown in FIG. 8), or a combination of a partial planar surface and a partial curved surface. Besides, as shown in FIG. 9, a light-guiding microstructure 46 may be formed on the first light incident surface 32a or the second light incident surface 32b to increase the light input uniformity.

In summery, the embodiment or embodiments of the invention may have at least one of the following advantages.

According to the above embodiments, the light guide plate has a plurality of light incident surfaces slanted with different slopes, and a plurality of light sources have light-emitting surfaces correspondingly slanted with different slopes. Therefore, different viewing angles of a display device are achieved to allow viewers on a left-hand side and a right-hand side to see their respective images or to allow a stereoscopic visual effect for a viewer. Compared with conventional designs, since only one light guide plate is needed and the specific microstructures having gradually-varied inclined angles are not necessary, the fabrication costs are reduced and the product yield is increased. Besides, since the light sources are disposed on a single side of the light guide plate, the light output pattern and the overall luminous uniformity of the light guide plate is easily controlled and the light-utilization efficiency is increased.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A backlight module, comprising:
a light guide plate having a light incident side, a bottom side, and a light-emitting side, wherein the bottom side is opposite the light-emitting side, at least one first light incident surface and at least one second light incident surface are alternately arranged on the light incident side, and the first light incident surface forms an angle with the second light incident surface;
at least one first light source disposed adjacent to the first light incident surface, wherein a light beam emitted by the first light source is capable of entering the light guide plate through the first light incident surface; and
at least one second light source disposed adjacent to the second light incident surface, wherein a light beam emitted by the second light source is capable of entering the light guide plate through the second light incident surface, a central axis across a center of the light incident side divides the light guide plate into a first half and a second half, the light beam emitted by the first light source is capable of being guided towards the first half, the light beam emitted by the second light source is capable of being guided towards the second half, and the first light source and the second light source are alternately turned on and off in succession.

2. The backlight module as claimed in claim 1, wherein a light-emitting surface of the first light source is substantially parallel to the first light incident surface, and a light-emitting surface of the second light source is substantially parallel to the second light incident surface.

3. The backlight module as claimed in claim 1, wherein the first light incident surface is slanted with a positive slope, and the second light incident surface is slanted with a negative slope.

4. The backlight module as claimed in claim 1, wherein a light-emitting surface of the first light source is slanted with a positive slope, and a light-emitting surface of the second light source is slanted with a negative slope.

5. The backlight module as claimed in claim 1, wherein the first light incident surface comprises at least one of a planar surface and a curved surface, and the second light incident surface comprises at least one of a planar surface and a curved surface.

6. The backlight module as claimed in claim 1, wherein the light incident side further comprises a connecting surface connecting the first light incident surface and the second light incident surface, and an inclined direction of the first light incident surface slanted to the connecting surface is different from an inclined direction of the second light incident surface slanted to the connecting surface.

7. The backlight module as claimed in claim 6, wherein the first light incident surface and the second light incident surface are substantially symmetrical with respect to a central axis across a center of the connecting surface.

8. The backlight module as claimed in claim 1, further comprising:
a light-converging structure formed on the bottom side of the light guide plate to narrow a light emitting angle of the light guide plate in a vertical direction, wherein the vertical direction is substantially parallel to the central axis.

9. The backlight module as claimed in claim 8, wherein the light-converging structure comprises a V-shaped groove.

10. The backlight module as claimed in claim 1, further comprising:
a light-guiding microstructure formed on at least one of the first light incident surface and the second light incident surface.

11. A display device, comprising:
a light guide plate having a light incident side, a bottom side, and a light-emitting side, wherein the bottom side is opposite the light-emitting side, at least one first light incident surface and at least one second light incident surface are alternately arranged on the light incident side, and the first light incident surface forms an angle with the second light incident surface;
at least one first light source disposed adjacent to the first light incident surface, wherein a light beam emitted by the first light source is capable of entering the light guide plate through the first light incident surface, and a light-emitting surface of the first light source is substantially parallel to the first light incident surface to guide the light beam emitted by the first light source towards a left-hand side in space;
at least one second light source disposed adjacent to the second light incident surface, wherein a light beam emitted by the second light source is capable of entering the light guide plate through the second light incident surface, a light-emitting surface of the second light source is substantially parallel to the second light incident surface to guide the light beam emitted by the second light source towards a right-hand side in space, and the first light source and the second light source are alternately turned on and off in succession;
a display panel capable of displaying a left-side image and a right-side image alternately; and
an image light source synchronization unit displays the left-side image when the first light source device is turned on and the second light source device is turned off and displays the right-side image when the first light source device is turned off and the second light source device is turned on.

12. The display device as claimed in claim 11, wherein the left-side image is provided for a viewer on the left-hand side and the right-side image is provided for a viewer on the right-hand side.

13. The display device as claimed in claim 11, wherein the left eye and the right eye of a viewer observe the right-side image and the left-side image, respectively.

14. The display device as claimed in claim 11, wherein the light-emitting surface of the first light source is slanted with a positive slope, and the light-emitting surface of the second light source is slanted with a negative slope.

15. The display device as claimed in claim 11, wherein the first light incident surface comprises at least one of a planar surface and a curved surface, and the second light incident surface comprises at least one of a planar surface and a curved surface.

16. The display device as claimed in claim 11, wherein the light incident side further comprises a connecting surface connecting the first light incident surface and the second light incident surface, and an inclined direction of the first light incident surface slanted to the connecting surface is different from an inclined direction of the second light incident surface slanted to the connecting surface.

17. The display device as claimed in claim 11, further comprising:
a light-converging structure formed on the bottom side of the light guide plate to narrow a light emitting angle of the light guide plate in a vertical direction.

18. The display device as claimed in claim 17, wherein the light-converging structure comprises a V-shaped groove.

19. The display device as claimed in claim 11, further comprising:
a light-guiding microstructure formed on at least one of the first light incident surface and the second light incident surface.

20. The display device as claimed in claim 11, wherein each of the first light source and the second light source comprises a light-emitting diode.
